(19) United States
(12) Patent Application Publication
(10) Pub. No.: US 2010/0132121 A1
(43) Pub. Date: Jun. 3, 2010

(54) SUPPORT CUSHION FOR FAST INFLATION AND DEFLATION

(76) Inventor: Richard CHAO, Taipei City (TW)

Correspondence Address: Muncy, Geissler, Olds & Lowe, PLLC, 4000 Legato Road, Suite 310, FAIRFAX, VA, 22033, US

(21) Appl. No.: 12/700,435

(22) Filed: Feb. 4, 2010

Related U.S. Application Data
(63) Continuation-in-part of application No. 11/406,250, filed on Apr. 19, 2006.

(51) Int. Cl. A47C 16/00; F16K 15/20

(52) U.S. Cl. 5/655.3; 137/223

(57) ABSTRACT

A support cushion for fast inflation and deflation comprises an air pouch and an air valve located on the air pouch. The air valve includes a valve base, a valve cover, a valve pillar and a locking member. The valve base has at least one air vent leading to the air pouch. The valve cover is coupled on the valve base to form an accommodating trough to accommodate the valve pillar. The valve pillar has a first opening and a second opening communicated with each other. The valve pillar also has a first position relative to the valve base to allow air to pass and a second position to block the airflow. The locking member can receive a turning force to drive the valve pillar to switch between the first and second positions. Operation is simpler and faster switch can be achieved, and leakage of air can be avoided.

This application is a continuation-in-part, and claims priority, of from U.S. patent application Ser. No. 11/406,250 filed on Apr. 19, 2006, entitled “AIR VALVE STRUCTURE FOR INFLATABLE ARTICLES”.

### FIELD OF THE INVENTION

The present invention relates to a support cushion for fast inflation and deflation and particularly to an inflation support cushion that is airtight and easy to use.

### BACKGROUND OF THE INVENTION

Inflation support cushion is widely used for medical or rehabilitation purpose, and can be put on hands, feet, waist or neck, or can be carried to support user's joints for preventing from impact. In a conventional support cushion, aside from selecting a desired outer layer material to contain gas, an air valve to inflate and deflate the gas is the most important element. In an inflated condition the air valve determines the internal pressure of gas stored in the support cushion and thus affects the support and protection effect thereof.

U.S. Pat. No. 4,728,075 discloses an apparatus for the control of fluid flow. It includes a control valve containing a valve and a valve base mating each other. The valve and valve base are coupled with an adjustment ring to enable the valve to move against the valve base. The valve and valve base further are bridged by a metering plug. When the valve is turned against the valve base the metering plug is separated from the valve and forms a gap with the valve, air can flow from one end of the valve through the gap into one end of the valve base to perform inflation. However, during inflation the metering plug is not being gripped by any means, hence is easily displaced or impacted by external forces, and moved in the space formed between the valve base and valve. Airflow could be hindered or inflation air pressure could be unstable.

U.S. Pat. No. 1,580,694 discloses an pipe coupling which comprises a handle, a valve cap connecting to the handle, a rod running through the valve cap, a valve located between the handle and the rod, and a hub located on the valve cap. The rod has a boss at the bottom end butting the valve. During inflation the rod is screwed in threads formed on the inner wall of the hub so that the boss presses the valve, meanwhile the side wall of the valve moves away from the valve cap so that air can flow through air vents formed on the side wall of the valve. After inflation is finished, the rod is released and the valve is pushed by the internal pressure to press the valve cap and return the original location to form an airtight condition. In such a structure the valve also moves without any retaining means, structural stability is not desirable during switching of airtight and air flowing conditions. Moreover, in the airtight condition the valve butts the value cap through merely the internal air pressure without support of a mechanical means, hence air leakage easily takes place. Inadvertent impact also easily causes escaping of the valve and results in air leakage.

U.S. Pat. No. 2,936,935 discloses a fluid connector which comprises a valve cap with an opening formed in the center, a valve pillar running through the valve cap opening to form a tight coupling therewith, and a valve base coupling with the valve cap. The valve cap has a flange inside. The valve pillar has one end formed a stepped coupling portion with a hole in the center. The valve base has an indented coupling surface and a round boss located in the center of the coupling surface to form a tight coupling with the coupling portion. The coupling portion and the flange of the valve cap are coupled closely. When in use the coupling portion is movable between a first position and a second position. When the coupling portion is at the first position the apparatus is closed. When the coupling portion is at the second position, the apparatus is open. The apparatus may be used on a container which holds liquid or powder to control dispensing of the liquid or powder. The container does not require a greater internal pressure. By closely coupling of the coupling portion and the round boss, and closely connection with the valve cap flange, leakage of the liquid or powder can be prevented. But adopted such a structure on a nursing apparatus filled with air, the internal air pressure could be excessively high under squeezing, and the valve pillar could also move under the air pressure to form a gap between the coupling portion and the round boss, and result in air leakage through the gap.

U.S. Pat. No. 3,276,640 discloses an air valve which has a flange and a coupling portion. The air valve is closed when the coupling portion is beneath the flange, and the air valve is open when the coupling portion is above the flange. Open and closed is controlled through the relative positions of coupling portion and the flange in the valve cap. It is also applicable to liquid containers. Adopted on the inflation nursing apparatus, as the nursing apparatus has a greater internal air pressure, and the surface of the inflation nursing apparatus is easily subject to squeezing and results in increasing of the internal pressure, leakage easily occurs.

### SUMMARY OF THE INVENTION

The primary object of the present invention is to overcome the foregoing shortcomings and prevent air from leaking through the air valve to cause drop of air pressure in an inflation object and result in ineffective support.

To achieve the foregoing object the present invention provides a support cushion for fast inflation and deflation which comprises an air pouch containing an orifice and an inflation chamber, and an air valve located on the air pouch. The air valve includes a valve base disposed in the orifice. The valve base has at least one air vent leading to the inflation chamber. The air valve also includes a valve cover coupling with the valve base to form an accommodating trough. The valve cover includes a connecting portion extended from the surface thereof, a through hole in the connecting portion and at least one anchor member located on a side wall of the connecting portion. The air valve further has a valve pillar located in the accommodating trough that contains an isolating portion and a tube located on the isolating portion and run through the through hole. The isolating portion has at least one first opening located on a side wall thereof and the tube has a second opening at the top end thereof communicating with the first opening. The isolating portion further has a butting surface at the bottom. The valve pillar has a first position relative to the valve base such that the butting surface is moved away from the air vent and a second position relative to the valve base such that the butting surface blocks the air vent. The tube further has a butting portion. The air valve also has a locking member coupling with the butting portion of the valve pillar. The locking member has a through hole run through by the tube and at least one track which accommodates the anchor member and has at least one elevation difference between two ends. Upon the locking member receiving a turning force the track moves a displacement relative to the anchor member to switch the valve pillar between the first position and the second position.

When the locking member is turned the valve pillar is moved up and down in the accommodating trough at the first position to allow air to flow through the air vent and the first opening, and at the second position to stop airflow through the air vent and the first opening, thus a fast switching between a flowing condition and a sealing condition can be accomplished. In the sealing condition, a retaining relationship is formed between the locking member and the valve pillar, and the butting surface tightly seals the air vent to prevent air leakage caused by inadvertent touching or excessive air pressure. Thus, the structure is simpler, air tightness is enhanced and operation is much easier.

### BRIEF DESCRIPTION OF THE DRAWINGS

FIG. 1 is a perspective view of an embodiment of the support cushion according to the present invention.

FIG. 2 is a perspective view of an embodiment of the air valve of the support cushion according to the present invention.

FIG. 3 is an exploded view of an embodiment of the air valve of support cushion according to the present invention.

FIG. 4A is a sectional view of an embodiment of the present invention showing the valve pillar at the first position.

FIG. 4B is a sectional view of an embodiment of the present invention showing the valve pillar at the second position.

FIG. 5A is a perspective view of an embodiment of the present invention showing the valve pillar at the first position.

FIG. 5B is a perspective view of an embodiment of the present invention showing the valve pillar at the second position.

### DETAILED DESCRIPTION OF THE PREFERRED EMBODIMENTS

The present invention will now be described in more detail hereinafter with reference to the accompanying drawings as follows:

To make it easier to fully understand the object of the invention, its structure, innovative features, and performance, a preferred embodiment together with the attached drawings for the detailed description of the invention is provided below. Only some embodiments of the present invention have been illustrated in the drawings, but it should be noted that many other modifications are conceivable within the scope of the following claims.

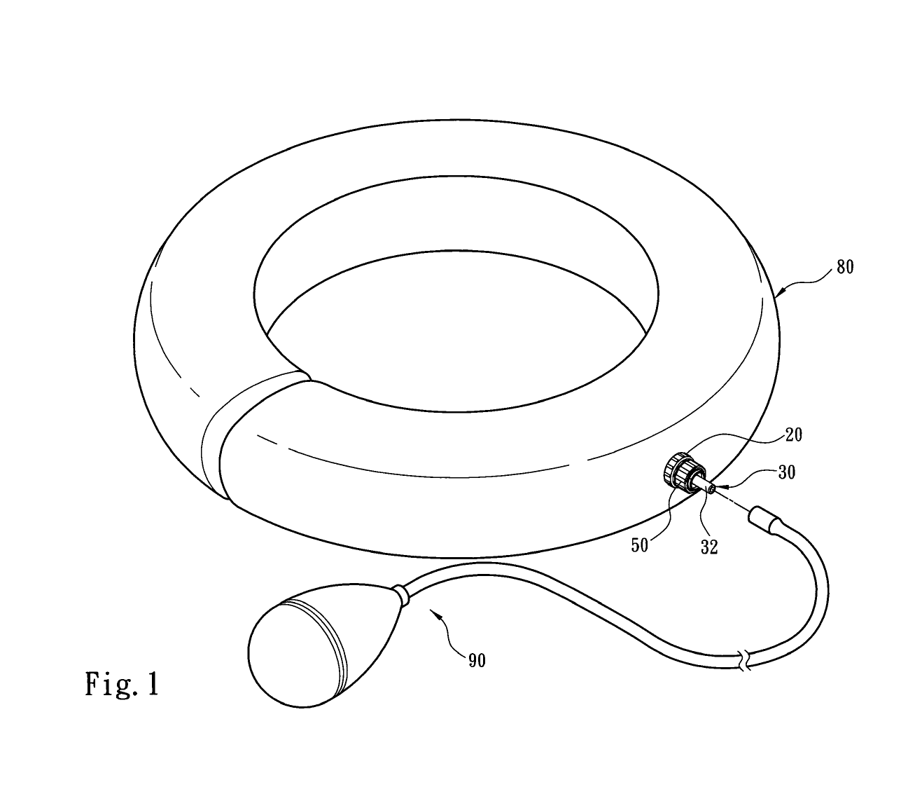

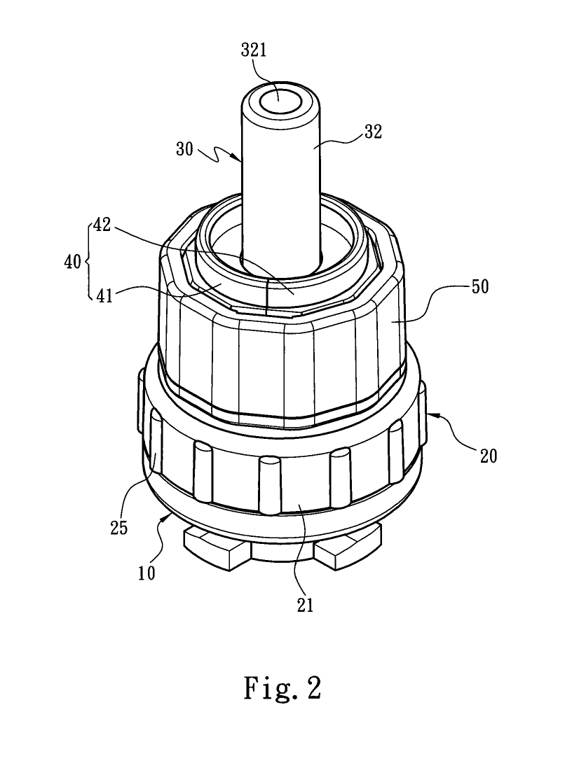

Please refer to FIGS. 1 through 4A for an embodiment of the invention. The support cushion of the present invention comprises an air pouch 80 and an air valve located on the air pouch 80. The air pouch 80 includes an orifice 81 and an inflation chamber. The air valve is connected to an inflation device 90 and includes a valve base 10 located in the orifice 81, a valve cover 20 fastened to an upper end of the valve base 10, a valve pillar 30 located between the valve base 10 and the valve cover 20, a locking member 40 coupled on the valve cover 20 and a retaining member 50 coupled on the locking member 40. The valve base 10 has at least one air vent 11 which is formed annularly on the valve base 10 in an equally spaced fashion. The valve base 10 also has a coupling portion 12 on the periphery. The valve base 10 contains a sealing ring 13 outside of the air vents 11. The valve cover 20 is coupled with the coupling portion 12 so that the valve cover 20 and the valve base 10 are joined to form an accommodating trough 21. The valve cover 20 includes a connecting portion 22 on the surface thereof, a through hole 23 located in the connecting portion 22 and at least one anchor member 24 jutting from a side wall of the connecting portion 22. The valve cover 20 and the valve base 10 are interposed by a first tight ring 60 which is squeezed by the valve cover 20 so as to prevent air leakage. In addition, the valve cover 20 has at least one ridge 25 formed on the outer wall to facilitate user gripping when in use.

The valve pillar 30 is located in the accommodating trough 21, and includes an isolating portion 31 and a tube 32 located on the isolating portion 31. The tube 32 runs through the through hole 23 and has a butting portion 33 extended outwards from the side wall. The isolating portion 31 has at least one first opening 311 on the side wall thereof, and the tube 32 has a second opening 321 on the top end thereof. The first and second openings 311 and 321 communicate with each other to allow airflow to pass through. In addition, the isolating portion 31 has a butting surface 312 at the bottom. The tube 32 has at least one second tight ring 70 interposed between the tube 32 and the connecting portion 22. The second tight ring 70 is squeezed to prevent air from leaking between the tube 32 and the connecting portion 22. Moreover, the tube 32 is connected to the inflation device 90 which supplies air through the second opening 321, first opening 311 and air vent 11 to the inflation chamber.

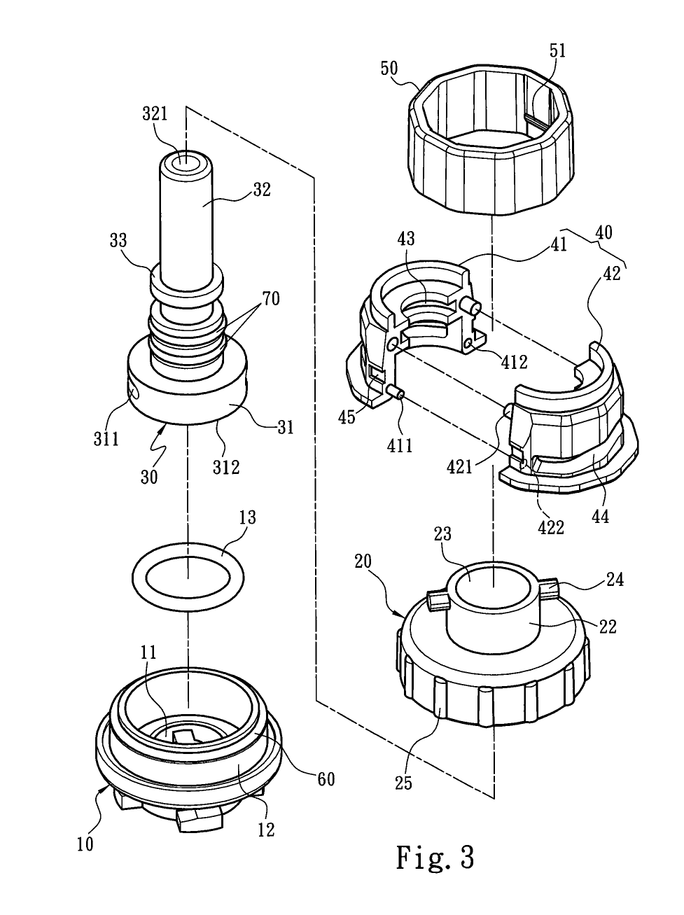

Referring to FIG. 3, the locking member 40 and the valve cover 20 are coupled together. The locking member 40 has a recess 43 on an inner wall coupled with the butting portion 33. In this embodiment the locking member 40 includes a first fastening portion 41 and a second fastening portion 42. The first and second fastening portions 41 and 42 have respectively a plurality of first anchor struts 411, first anchor holes 412, second anchor struts 421 and second anchor holes 422 corresponding each other to form a latch structure for coupling, thereby the first fastening portion 41 and the second fastening portion 42 can be fastened together securely. In addition, the locking member 40 has an aperture run through by the tube 32 and at least one track 44 to accommodate the anchor member 24. The track 44 is located on a side wall of the locking member 40 and the track 44 has at least one elevation difference at two ends thereof. The retaining member 50 is coupled on the outer side of the locking member 40 and has an inner wall with at least one jutting latch member 51 formed thereon. The latch member 51 is coupled with at least one trough 45 formed on the locking member 40 to prevent the first and second fastening portions 41 and 42 from separating and also thus an anchoring relationship can be formed between the locking member 40 and the retaining member 50.

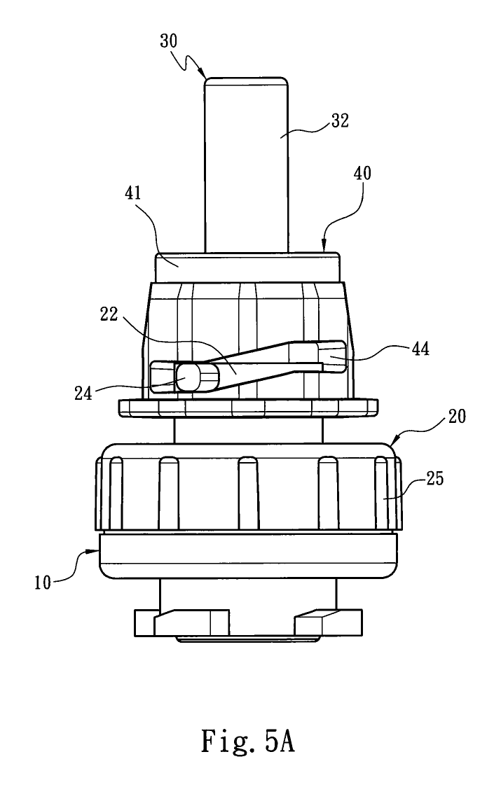

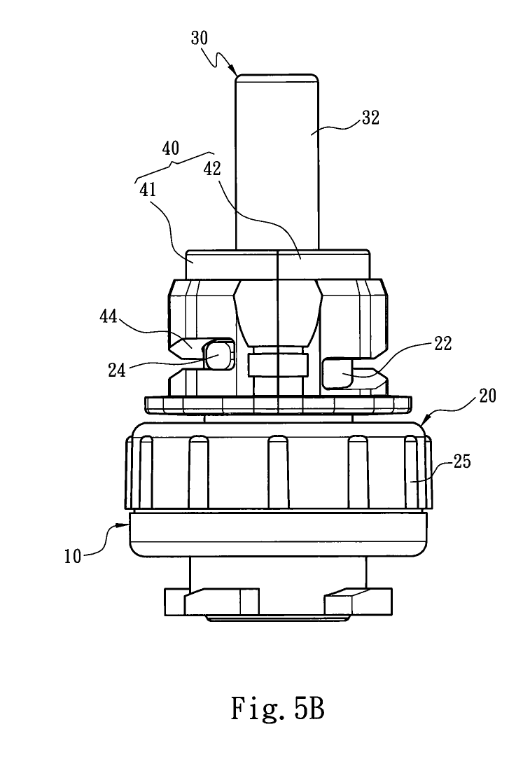

Referring to FIG. 5A, the valve pillar 30 is held in the accommodating trough 21. When the anchor member 24 is located at a lower end of the track 44 the valve pillar 30 is at a first position relative to the valve base 10 with the butting surface 312 moved away from the air vent 11, and the isolating portion 31 butts the upper end of the accommodating trough 21 so that the air vent 11 can communicate with the first opening 311. In this embodiment the air flows through the second opening 321 of the tube 32 to the first opening 311 of the isolating portion 31 to proceed inflation. In practice, depending on requirements, air also may flow through the first opening 311 to the second opening 321 to perform inflation. Moreover, the second tight ring 70 on the tube 32 pressed the wall of the connecting portion 22, and the first tight ring 60 interposed between the valve cover 20 and valve base 10 can prevent air leakage. Hence the second opening 321, first opening 311 and air vent 11 form a closed flow path. The first tight ring 60, second tight ring 70 and sealing ring 13 may be circular rings made from elastic material to provide airtight and buffer effect.

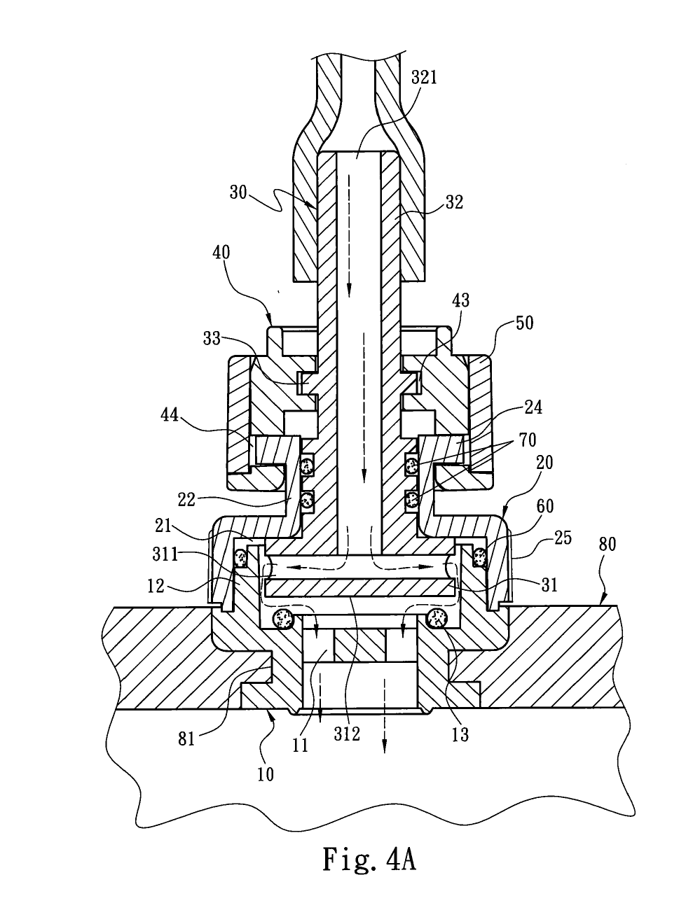

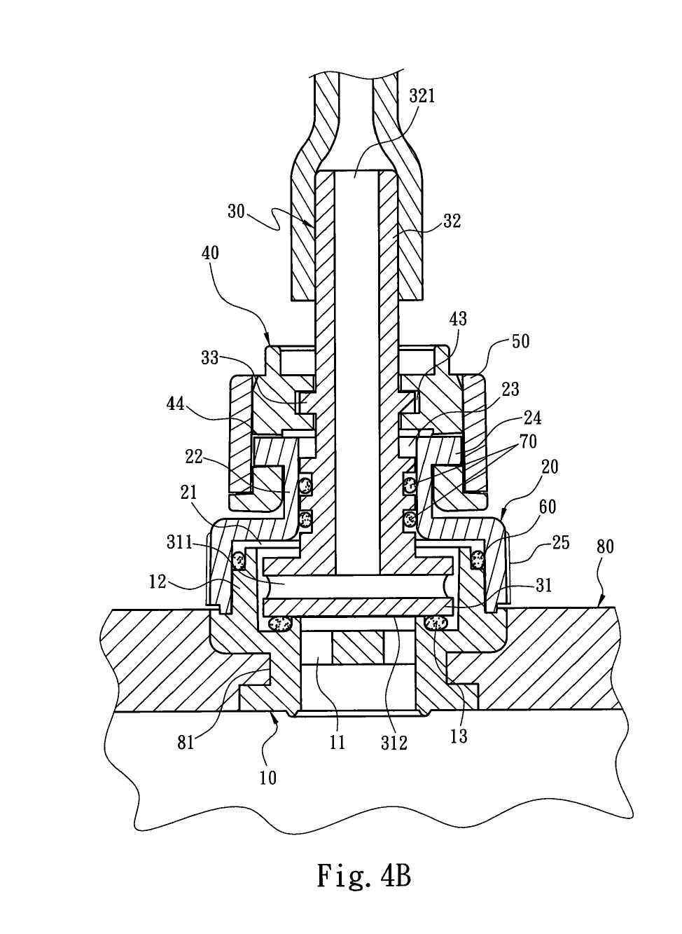

Referring to FIGS. 4B and 5B, when inflation is finished, user can grip the ridge 25 of the valve cover 20 to turn the retaining member 50. The locking member 40 will thus receive a turning force since the retaining member 50 is latched on the locking member 40. The track 44 move a displacement relative to the anchor member 24, and the anchor member 24 is moved from a lower end of the track 44 (as shown in FIG. 5A) to a higher end (as shown in FIG. 5B); meanwhile, the locking member 40 moves downwards relative to the anchor member 24 and drives the valve pillar 30 downwards, and the butting surface 312 of the isolating portion 31 presses the sealing ring 13 of the valve base 10, and thus the valve pillar 30 is at a second position relative to the valve base 10 with the butting surface 312 blocks the air vent 11, hence the isolating portion 31 closes the air vent 11 and air cannot pass through the air vent 11 to the first opening 311, or through the first opening 311 to the air vent 11. Hence, by turning the locking member 40 to adjust the valve base 10 to the first position air generated by the inflation device 90 can be sent to the inflation chamber. After the air pouch 80 is filled with a desired air pressure, turn the locking member 40 to switch the valve base 10 from the first position to the second position, air leakage can be prevented and air pressure in the air pouch 80 can be maintained as desired.

As a conclusion, the support cushion of the present invention relies on movements of the track and the anchor member to switch the valve pillar in the accommodating trough between the first position and second position so that a flowing condition and a sealing condition can be switched quickly and efficiently. At the flowing condition the isolating portion butts the valve cover to inhibit air from leaking at the upper side, but merely allow the air to pass through the first opening to the air vent. At the sealing condition, the butting surface of the isolating portion presses the sealing ring, incorporating with the first and second tight rings, air leakage can be prevented. Thus the present invention provides a simpler structure and improved usability, and can switch quickly and maintain a desired airtight condition. The air pouch can be designed in various shapes according to human body portions, and become a support cushion adaptable to human hands, feet, waist, chest, neck, leg, or other products such as joint nursing outfits to be carried outdoors by patients.

While the present invention has been described by means of specific embodiments, numerous modifications and variations could be made thereto by those skilled in the art without departing from the scope and spirit of the present invention set forth in the claims.

In summation of the above description, the present invention provides a significant improvement over the conventional techniques and complies with the patent application requirements, and is submitted to the Patent and Trademark Office for review and granting of the commensurate patent rights.

What is claimed is:

1. A support cushion for fast inflation and deflation, comprising:
an air pouch containing an orifice and an inflation chamber; and
an air valve which is disposed on the air pouch and includes:
a valve base which is located in the orifice and contains at least one air vent leading to the air chamber;
a valve cover which is coupled with the valve base to form an accommodating trough and includes a connecting portion extended from the surface thereof, a through hole located in the connecting portion and at least one anchor member located on a side wall of the connecting portion;
a valve pillar which is located in the accommodating trough and includes an isolating portion and a tube located on the isolating portion which run through the through hole, the isolating portion containing at least one first opening on a side wall and a butting surface at the bottom thereof, and the tube containing at least a second opening on the top end thereof communicating with the first opening, the valve pillar having a first position relative to the valve base such that the butting surface is moved away from the air vent and a second position relative to the valve base such that the butting surface blocks the air vent, the tube containing a butting portion; and
a locking member which is coupled to the butting portion and includes an aperture run through by the tube and at least one track which accommodates the anchor member and has at least one elevation difference between two ends, upon the locking member receiving a turning force the track moves a displacement relative to the anchor member to switch the valve pillar between the first position and the second position.

2. The support cushion for fast inflation and deflation support cushion of claim 1, wherein the valve base contains a coupling portion connecting to an inner wall of the valve cover.

3. The support cushion for fast inflation and deflation support cushion of claim 1, wherein the valve base and the valve cover are interposed by a first tight ring.

4. The support cushion for fast inflation and deflation support cushion of claim 1, wherein the tube and the connecting portion are interposed by a second tight ring.

5. The support cushion for fast inflation and deflation support cushion of claim 1, wherein the valve base contains a sealing ring outside of the air vent, the sealing ring being pressed by the butting surface of the isolating portion at the second position of the valve pillar.

6. The support cushion for fast inflation and deflation support cushion of claim 1, wherein the locking member is coupled with a retaining member peripherally.

7. The support cushion for fast inflation and deflation support cushion of claim 1, wherein the locking member includes a first fastening portion and a second fastening portion that are coupled through a latch structure.

8. The support cushion for fast inflation and deflation support cushion of claim 1, wherein the valve cover contains at least one ridge to facilitate user gripping.

9. The support cushion for fast inflation and deflation support cushion of claim 1, wherein the butting portion is formed at a cross section greater than the aperture.

10. The support cushion for fast inflation and deflation support cushion of claim 1, wherein the air vents are formed annularly on the valve base in an equally spaced manner.
